(19) United States
(12) Patent Application Publication
(10) Pub. No.: US 2012/0179390 A1
(43) Pub. Date: Jul. 12, 2012

(54) DISTRIBUTED FIBRE OPTIC DIAGNOSIS OF RISER INTEGRITY

(76) Inventors: Stephen Kimmiau, Sudbury (GB); Arthur Hartog, Winchester (GB); Gareth Lee, Southampton (GB); Azedine Kacher, Paris (FR)

(21) Appl. No.: 13/120,432

(22) PCT Filed: Sep. 23, 2009
(86) PCT No.: PCT/GB2009/002267

§ 371 Date: Feb. 21, 2012

Related U.S. Application Data
(60) Provisional application No. 61/099,579, filed on Sep. 24, 2008.

(51) Int. Cl. G06F 19/00; G06F 15/00

(52) U.S. Cl. 702/35; 702/42; 702/134; 702/45

(57) ABSTRACT

A subsea riser integrity diagnosis system comprising: one or more fibres deployed along a riser, preferably along the whole length subject to any potential failure, or alternatively deployed over the interval most subject to failure, a fibre optic sensor interrogation apparatus optically coupled to the fibre(s) and operable to detect changes in temperature (DTS), vibration (CRN), or strain (FBG) sensed by the fibre optic strain sensor, and a central processor means adapted to receive multiple measurement data from the interrogation apparatus and operable to determine from the received data the current status of temperature, pressure, vibration, strain or other parameters along the riser and to determine if the status is within safe limits or whether any number of potentially damaging events has occurred and to inform the operator(s) for possible action to be taken to safeguard the integrity of the riser.

The invention relates to a subsea riser integrity diagnosis system using fibre optic sensors, and specifically to the use of a distributed measurement system such as distributed temperature sensing (DTS) or coherent Rayleigh noise (CRN) or multiple fibre-Bragg grating (FBG) sensing regions for temperature, vibration or strain using an array of single point sensors suitably deployed, or other fibre optic detection techniques.

Subsea hydrocarbon production systems using sea surface facilities of any sort require petroleum fluids to flow from the seabed to the surface through pipes called risers. The sea surface rises and falls with waves and tides and the facilities are moved vertically, laterally and rotationally by various forces. The risers can either be steel pipes relying on their intrinsic flexibility or a range of flexible composite materials that are designed to resist the internal conveyance of fluids and the external forces imposed by all foreseen conditions. It is vital that these risers do not leak petroleum fluids to the environment, and do not suffer mechanical failures which would require production to be stopped, causing severe loss of revenue. In order to ensure hydraulic and mechanical integrity of risers a wide variety of periodic inspection techniques and permanent sensing systems are employed in the industry. Types of potentially damaging events may include, but are not limited to: Excessive strain and potential for fatigue damage, Extreme sea state conditions, Extreme temperature and temperature variation, Extreme flow conditions, such as slugging, Leaks either of produced fluids out of the riser or seawater in, Breakage of armour wires in flexible risers, Third party interactions: such as collision with surface or subsurface vessels, intimate marine life, and others.

U.S. Pat. No. 7,296,480 assigned to Technip France describes a method and device for monitoring a flexible pipe using a sensing device located at the top of the riser, but this cannot respond to damage to the armour wires which may be hundreds or even over a thousand metres away on the seabed, this document also refers to other periodic riser pipe inspection methods which do not have the advantages of permanent monitoring. U.S. patent application US20050139138 proposes using multiple sensors along a riser for the purpose of flow assurance monitoring; that is preventing internal fluids from causing blockages. US patent GB2416871 assigned to Schlumberger describes using the analysis of distributed temperature sensor data to infer the downhole flow of fluids in oil wells, similar analysis methods are proposed to diagnose riser integrity.

### SUMMARY OF THE INVENTION

According to a first aspect of the present invention there is provided subsea riser integrity diagnosis system comprising:
one or more fibres deployed along along a riser, preferably along the whole length subject to any potential failure, or alternatively deployed over the interval most subject to failure. The fibre(s) may either be built into the structure of the riser at manufacture, or alternatively attached with a variety of means to the outer part of the riser after manufacture, or even attached externally whilst in service,
a fibre optic sensor interrogation apparatus optically coupled to the fibre(s) and operable to detect changes in temperature (DTS), vibration (CRN), or strain (FBG) sensed by the fibre optic strain sensor,
and a central processor means adapted to receive multiple measurement data from the interrogation apparatus and operable to determine from the received data the current status of temperature, pressure, vibration, strain or other parameters along the riser and to determine if the status is within safe limits or whether any number of potentially damaging events has occurred and to inform the operator(s) for possible action to be taken to safeguard the integrity of the riser.

A fibre-optic distributed temperature sensing (DTS) system measures temperature continuously along a fibre, often installed in a small steel pipe 0.25 inches in outer diameter, termed a hydraulic ‘control line’, although other means of deployment are also used. Typically the DTS system measures with a spatial resolution of 1 metre, and acquires a complete temperature trace along the whole fibre every 1-5 minutes, although these parameters are controlled by the interrogation apparatus. The fibre responds to the temperature of its immediate environment, which is either that of the structure to which the control line is thermally and mechnically bonded, or that of a surrounding fluid. In a typical ‘double-ended’ DTS installation two control lines are installed at different locations on the riser with a ‘turn-around’ loop at the end creating a single, U-tube, continuous fluid-tight conduit along which an optical fibre can be installed. Fibre-optic fibres and their deployment protection are small and relatively flexible, allowing installation in a wide variety of positions in different riser systems. For examples of various possible installation positions see figures.

If installed at suitable locations a DTS fibre can measure a range of temperatures; either an average temperature of the bulk riser structure, a temperature close to the internal fluid temperature, a temperature close to the external environment temperature, or even a particular layer or component within a complex riser or “production bundle” structure. A production bundle is a type of riser containing several pipes and/or heating elements; wide varieties are used within the industry.

A single DTS measurement can of course only measure a single temperature at a particular location, although other temperatures may be inferred to greater or lesser accuracy from this measurement. In some cases this single measurement made versus time and depth may be diagnostic in itself of a riser integrity issue, for example a large cooling event may be diagnostic of a loss of thermal insulation. However because of inhomogeneities in the thermal structure of the riser and its environment, differences in measured temperatures between two or more fibres can be diagnostic of more subtle conditions of a flexible or steel riser that lead to an increased risk of failure, such as fluid invasion, corrosion, armour wire breakage, or other events. When in a typical ‘double-ended’ DTS installation two control lines are installed at different locations on the riser with a ‘turn-around’ loop at the remote end, a single continuous fibre will give two temperature measurements at every point along the riser. This type of installation has several advantages over the use of two separate ‘single-ended’ fibres.

A fibre-optic distributed Coherent Rayleigh Noise (CRN) system responds to vibration continuously along fibres. Typically the CRN system measures, with a spatial resolution of 10 metres, and acquires a complete vibration trace every few seconds. The fibre responds to vibration in its immediate environment, which is typically (similar to that employed for DTS) a 0.25 in (6.4 mm) stainless steel hydraulic ‘control line’. Fibre sensitivity to vibration varies from point and with the effectiveness of coupling between the sensing fibre and the conveying control line, hence the CRN technique does not provide a calibrated microphonic detector, but rather a vibration detection system which can discriminate frequency. As for DTS a CRN fibre system can also be installed in a wide variety of positions in different riser systems. A feature of CRN measurement is that the coupling between the fibre and its deployment protection is important, and that various fluids, gels, or solids may be employed to obtain the desired coupling. The response of the CRN measurement to its environment is mechanically complex, but unlike DTS the response can be very fast (times of about 5 milliseconds) and vibrations generated at a considerable distance (up to several metres) away from the fibre can be detected.

Although systems can use separate, dedicated fibres for the DTS and CRN measurements, it is also possible to use the same fibre for both types of measurements by a variety of multiplexing techniques. The two types of measurement have complementary features which make their combination a more sensitive and reliable integrity diagnostic tool then either alone.

In addition to distributed DTS and CRN and other measurements, fibre-Bragg grating (FBG) sensors may be incorporated in an optical fibre at many points, which respond to changes in elongation and refractive index caused by strain and temperature. These FBGs may be variously configured to measure tension, bending, torsion, temperature, vibration or other parameters of the structure in which they are deployed. Pressure is one of the most important parameters for riser operations, and FBG devices may be employed to respond to the hoop strain and hence pressure, at many points in the riser system. Strain is the basic physical parameter generally most important to the fatigue lifetime of pipelines. In flexible or highly-stressed risers the strain, as well as the internal pressure, is needed for safe operation.

The subsea riser integrity diagnosis system may comprise one or more optical fibres forming a distributed measurement system using one or more types of sensor. The optical fibre(s) is/are preferably arranged within the riser structure such that in use it has appropriate response sensitivity, being able to detect the smallest events of interest for integrity monitoring, whilst at the same time being able to measure very large and infrequent events.

The fibre optic interrogation apparatus may comprise a Brillouin or Rayleigh scattering distributed sensor interrogation apparatus.

The fibre optic FBG sensor interrogation apparatus may comprise a wavelength division multiplexed fibre grating interrogation apparatus or a time division multiplexed fibre grating interrogation apparatus.

### DRAWINGS

FIG. 1 describes the overall system of optical fibre sensors mounted on or in a subsea riser, the interrogation apparatus, and the central processor which outputs the integrity diagnosis to the operators system.

FIG. 2 shows a typical flexible riser cross-section at A, a complex production bundle at B, and a simple steel riser or flowline with optional insulation at C.

FIG. 3 shows two typical DTS temperature measurements, from a shut-in riser and a flowing riser, and the theoretically estimated flowing fluid temperature.

FIG. 4A shows a section of a production bundle riser with fibre optic sensors, fluid injection tubes, and four electrical heating elements, in 4B two extra fibres are added.

FIG. 5 shows flowing and shut-in DTS temperature measurements in a production bundle riser, and the effect of electrical heating on nearby sensing fibres.

FIG. 6 shows three flowing DTS temperature measurements at successive time intervals, and the calculated rate of change of temperature with time.

FIG. 7 shows CRN vibration spectral plots of vibration amplitude versus frequency and amplitude versus time as a function of depth interval along the sensor fibre.

### DETAILED DESCRIPTION OF THE INVENTION

The proposed methodology is as follows:

The system preferably comprises a plurality of sensors along the riser and at each point within the riser structure. The plurality of sensors may be provided within a single optical fibre. The advantage of a distributed sensing system is that the complete riser, of several kilometres lengths, may be monitored, as compared to systems which only monitor a single point, such as the top of the riser.

The sensors are embodied in one or more fibres deployed along along a riser, preferably along the whole length subject to any potential failure, or alternatively deployed over the interval most subject to failure. The fibre(s) may be built into the structure of the riser at manufacture, or alternatively attached with a variety of means to the outer part of the riser after manufacture, or even whilst in service.

Measurements are recorded by a fibre optic sensor interrogation apparatus optically coupled to the fibre(s) and operable to detect changes in temperature (DTS), vibration (CRN), or strain (FBG) sensed by the fibre optic strain sensors.

Attached to the sensor interrogation apparatus is a central processor means adapted to receive multiple measurement data simultaneously and operable to determine from the received data the current status of temperature, pressure, vibration, strain or other parameters along the riser, to derive from this data informative parameters such as the rate of change with time and space and the spectral distribution of events, to employ a feature detection or model-based detection algorithm, and hence to determine if the status is within safe limits or whether any number of potentially damaging events has occurred and to inform the operator(s) for possible action to be taken to safeguard the integrity of the riser.

The system is thereby able to provide a full integrity diagnosis along the pipe in real time or at periodic reporting times, giving a condition status. Key features are:
Detection: Detection of events that may impact on the quality or safety of the operation
Location: determining where in the length of the pipe the event is occurring
Measurement: quantification of key parameters
Diagnosis: Interpretation of events within the system context and diagnosis of which kind of event it is detecting and how severe it may be.
Indication of possible remediation: Suggest possible actions to remediate the problem.

The central processor means is preferably further operable to identify event types which may include:
Excessive strain and potential for fatigue damage
Extreme sea state conditions
Extreme temperature and temperature variation
Extreme flow conditions, such as slugging
Leaks: Either of produced fluids out of the riser or seawater in.
Breakage of armour wires in flexible risers.
Third party interactions: collision with fishing equipment, support vessels, ROVs, marine life, others.

The central processor means is preferably further operable to generate an alarm signal. The central processor means is preferably further operable to generate a control signal for transmission to a riser and/or production management system. The central processor means may be operable to decrease or increase the total flow rate within the riser, increase of decrease the internal pressure, increase or decrease electrical heating, inject gas, divert gas, or take other action as appropriate to ameliorate the detected potentially damaging situation.

Embodiments of the invention will now be described in detail, by way of example only, with reference to the accompanying drawings.

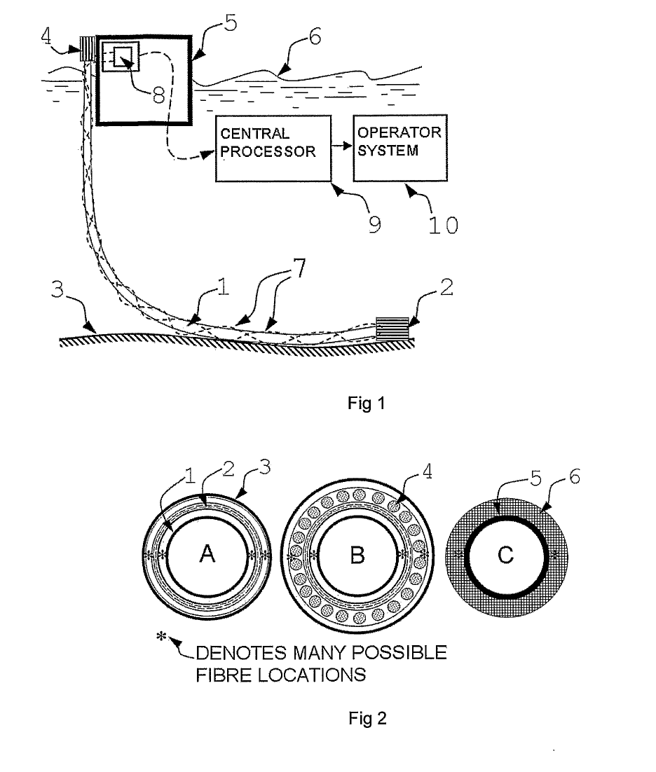

FIG. 1 illustrates the subsea riser integrity diagnosis system mounted on 1, a riser pipe carrying fluids from the bottom end fitting 2 on the seabed 3, to the top end fitting 4 mounted on the surface production facility 5 floating on the sea surface 6. The optical sensing fibre or fibres 7 are mounted on the riser and terminate in the interrogation unit 8 mounted on the surface production facility. Sensing signals from the fibre(s) are analysed by the central processing unit 9, which, if a potentially damaging condition occurs, notifies the surface production facility operators system, so that appropriate action may be taken.

FIG. 2 shows illustrations of three types of riser construction to highlight the several possible locations for installation of sensing fibres. In section A, a typical flexible riser comprises 1 a pressure barrier, 2 counter-wound layers of steel armour wires, and 3 external insulation and protection layers. Thin fibres can be installed in the plastic radial layers at smaller or larger diameters. In section B the flexible structure is made more complex by the addition of multiple tubes 4, which are used for a variety of tasks such as gas injection or riser heating. These complex risers are termed ‘production bundles’ and a wide variety are possible, with many options for internal fibre placement. In section C a single steel pipe 5 carries all loads, and may have an external insulation and protection layer 6, of a material such as polyethylene or closed-cell foam. In the simplest possible case the pipe has no external sheath, and the fibre installation lines are clamped or bonded directly to the steel pipe.

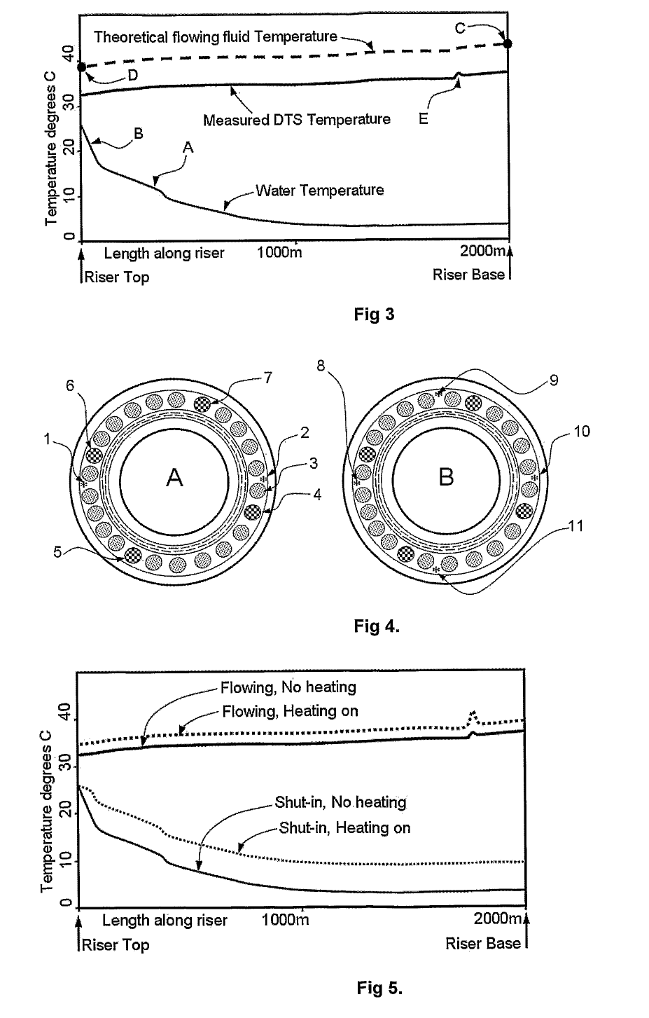

FIG. 3 graphs typical DTS temperature traces measured in a subsea production riser. Typically the measurement is referenced to fibre length from the top of the riser to the riser base, which in this example is 2 km. The lowest trace indicates the sea water temperature measured with no flow in the riser, and sufficient time given to allow thermal equilibrium to be established all along the riser. The deep sea water temperature is about 4 degrees C. At region A on this trace a warmer layer of sea water is evident, and at region B a rapid rise in temperature indicates the surface layers and the riser joining the surface production facility. When the riser is flowing with produced hydrocarbons, these enter the riser base at a temperature indicated by point C, flow up the riser gradually losing thermal energy and temperature to the cold seawater environment, and reach the surface at temperature D. The dashed curve labeled Theoretical flowing fluid Temperature shows this internal temperature from C to D. Because the DTS measurement fibre is not immersed in the flowing hydrocarbon but is installed in the riser structure at some distance away, it measures a slightly lower temperature, labelled Measured DTS Temperature. The measured DTS temperature is thus sensitive to the thermal conductivity of the riser layers, and features such as E are seen at the point of riser touch-down onto the seabed, where lower heat loss results.

FIG. 4 A shows a section of a production bundle riser, similar to that shown in FIG. 2B, with optical fibres sensing DTS temperature or CRN vibration, or both, at 1 and 2. In addition to the multiple fluid tubes such as 3, there are four electrical heating wires, shown at 4, 5, 6 and 7. Note that for optical fibre 1 heater 6 is close, heaters 5 and 7 at approx half a pipe diameter distance, and heater 4 diametrically opposed. For optical fibre 2 heater 4 is close, with the others symmetrically displaced. Note that the regions close to fibre 1 and 2 can be easily sensed, but sensitivity to local heating falls off with distance. In FIG. 4B a similar production bundle riser has four optical fibres at 8, 9, 10 and 11, allowing close response to all four quadrants of the riser.

FIG. 5 shows the effect of electrical heating on nearby sensing fibres, for example if in FIG. 4A heater 6 is on next to fibre 1, or heater 4 next to fibre 2, then the dotted temperature curves showing the effect of heating will result. The rate of temperature increase and the absolute value of increase in temperature achieved will be sensitive to the thermal conductivity and heat capacity of the materials between the heater and the fibre. Those skilled in the art of interpreting permanent monitoring data can perform comparative investigation of the internal structure of the riser by the analysis of these temperature traces and their response as a function of time.

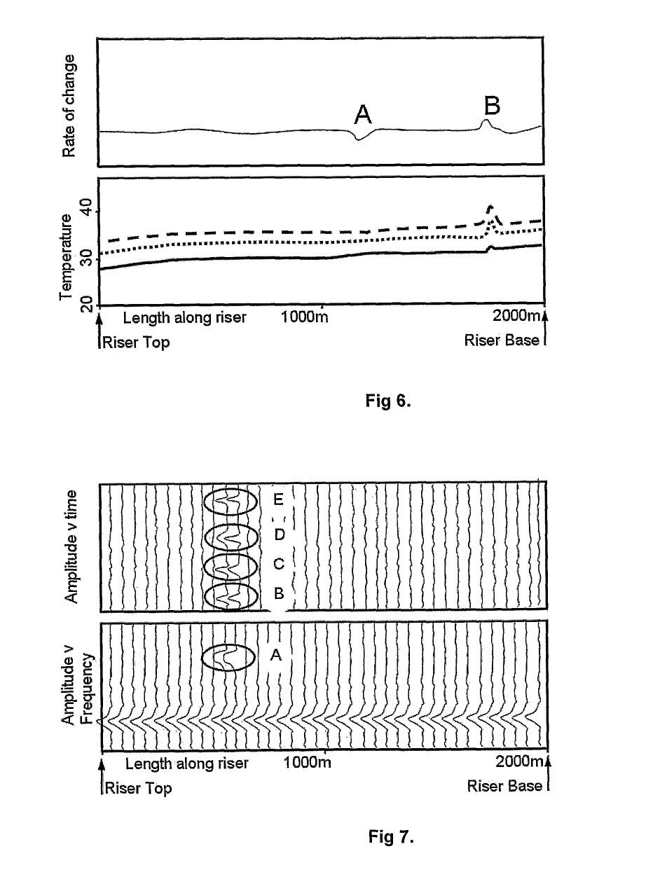

FIG. 6 illustrates the transformation of successive time DTS measurements into a rate of change of temperature plot which is characteristic of the thermal transmissivity properties of the riser. Three temperature curves coded solid, dotted, and dashed, represent DTS traces taken at successive time intervals, for example separated by five minutes. The curve in the rate of change of temperature plot above shows the numerical derivative calculated at each depth which is a diagnostic of riser properties. In this example feature A, a low rate of temperature increase, could be indicative of potential riser damage, whilst feature B, a high rate of increase, is indicative of partical riser seabed burial, due to trenching at the touch down point.

FIG. 7 shows CRN vibration measurements along a fibre such as that in FIG. 6. The lower plot shows multiple depth traces of vibration amplitude versus frequency. All traces show a common low frequency signature characteristic of facility induced noise. Feature A shows a high frequency noise component, localised in space. The amplitude versus time plot above shows a periodic noise signature at B, C, D and E. Those skilled in the art of interpreting fibre optic sensor monitoring data can perform comparative investigation of the internal structure of the riser by the analysis of these vibration signals and their response as a function of time.

Embodiments of the invention will now be described in detail, by way of example only, with reference to the accompanying drawings.

### EXAMPLE 1

### Multi-Fibre DTS System

A subsea riser DTS integrity diagnosis system can be embodied as in FIG. 1 with a looped fibre carried in a control line mounted in 1, a riser pipe carrying fluids from the bottom end fitting 2 on the seabed 3, to the top end fitting 4 mounted on the surface production facility 5 floating on the sea surface 6. The optical sensing fibre loop ends 7 are mounted on the riser and terminate in the interrogation unit 8 mounted on the surface production facility. The interrogation unit calibrates the temperature and separates two temperature traces corresponding to fibre positions 1 and 2 in FIG. 4A. Sensing signals from the fibre are analysed by the central processing unit shown in FIG. 1 part 9.

FIG. 3 graphs typical DTS temperature traces measured in a subsea production riser. Typically the measurement is referenced to fibre length from the top of the riser to the riser base, which in this example is 2 km. The lowest trace indicates the sea water temperature measured with no flow in the riser, and sufficient time given to allow thermal equilibrium to be established all along the riser. The deep sea water temperature is about 4 degrees C. At region A on this trace a warmer layer of sea water is evident, and at region B a rapid rise in temperature indicates the surface layers and the riser joining the surface production facility. When the riser is flowing with produced hydrocarbons, these enter the riser base at a temperature indicated by point C, flow up the riser gradually losing thermal energy and temperature to the cold seawater environment, and reach the surface at temperature D. The dashed curve labeled Theoretical flowing fluid Temperature shows this internal temperature from C to D. Because the DTS measurement fibre is not immersed in the flowing hydrocarbon but is installed in the riser structure at some distance away, it measures a slightly lower temperature, labeled Measured DTS Temperature. The measured DTS temperature is thus sensitive to the thermal conductivity of the riser layers, and features such as E are seen at the point of riser touch-down onto the seabed, where lower heat loss results. FIG. 5 shows the effect of electrical heating on nearby sensing fibres, for example if in FIG. 4A heater 6 is on next to fibre 1, or heater 4 next to fibre 2, then the dotted temperature curves showing the effect of heating will result. The rate of temperature increase and the absolute value of increase in temperature achieved will be sensitive to the thermal conductivity and heat capacity of the materials between the heater and the fibre. Those skilled in the art of interpreting permanent monitoring data can perform comparative investigation of the internal structure of the riser by the analysis of these temperature traces and their response as a function of time. FIG. 6 illustrates the transformation of successive time DTS measurements into a rate of change of temperature plot which is characteristic of the thermal transmissivity properties of the riser. Three temperature curves coded solid, dotted, and dashed, represent DTS traces taken at successive time intervals, for example separated by five minutes. The curve in the rate of change of temperature plot above shows the numerical derivative calculated at each depth which is a diagnostic of riser properties. In this example feature A, a low rate of temperature increase, could be indicative of potential riser damage, whilst feature B, a high rate of increase, is indicative of partical riser seabed burial, due to trenching at the touch down point. In this case feature A would be detected by the central processor means using a feature detection or model-based detection algorithm, and hence to determine if the status is within safe limits or whether any number of potentially damaging events has occurred and to inform the operator(s) for possible action to be taken to safeguard the integrity of the riser.

### EXAMPLE 2

### Combined DTS and CRN System

A combined DTS and CRN subsea riser integrity diagnosis system can be embodied as in FIG. 1 with a looped fibre carried in a control line mounted in 1, a riser pipe carrying fluids from the bottom end fitting 2 on the seabed 3, to the top end fitting 4 mounted on the surface production facility 5 floating on the sea surface 6. The optical sensing fibre loop ends 7 are mounted on the riser and terminate in the interrogation unit 8 mounted on the surface production facility. FIG. 2 shows illustrations of three types of riser construction to highlight the several possible locations for installation of sensing fibres. In section A, a typical flexible riser comprises 1 a pressure barrier, 2 counter-wound layers of steel armour wires, and 3 external insulation and protection layers. Thin fibres can be installed in the plastic radial layers at smaller or larger diameters. In section B the flexible structure is made more complex by the addition of multiple tubes 4, which are used for a variety of tasks such as gas injection or riser heating. These complex risers are termed ‘production bundles’ and a wide variety are possible, with many options for internal fibre placement. Fluid flow within these pipes can give rise to vibrations detectable by the CRN system. In section C a single steel pipe 5 carries all loads, and may have an external insulation and protection layer 6, of a material such as polyethylene or closed-cell foam. In the simplest possible case the pipe has no external sheath, and the fibre installation lines are clamped or bonded directly to the steel pipe.

The interrogation unit can determine DTS temperature and CRN vibration from the same fibre, or alternatively two units, one for DTS and one for CRN, can be employed on the same fibre fibre using an optical switch in time-share mode. The DTS unit calibrates the temperature and separates two temperature traces corresponding to fibre positions 1 and 2 in FIG. 4A. The CRN unit measures vibration along the riser and can produce data as shown in FIG. 7. The lower plot shows multiple depth traces of vibration amplitude versus frequency. All traces show a common low frequency signature characteristic of facility induced noise. Feature A shows a high frequency noise component, localized in space. The amplitude versus time plot above shows a periodic noise signature at B, C, D and E.

Sensing signals from the fibre derived by the interrogation unit or units are analysed by the central processing unit shown in FIG. 1 part 9. In this example the DTS data in FIG. 6 shows feature A, a low rate of temperature increase, which could be indicative of potential riser damage due to flooding of the riser annulus. The CRN processed data shown in FIG. 7 shows a different vibration feature, which has a periodic noise signature at B, C, D and E.

In this example the central processor means using a feature detection or model-based detection algorithm will combine the information from both DTS and CRN sensors and can determine if the status is within still within safe limits. For example the temperature feature A in FIG. 6 could be indicative of a potential site for corrosion, and hence if CRN data subsequently shows vibration at this point a warning signal can be generated. In general the combined data can be used to determine whether any number of potentially damaging events has occurred and to inform the operator(s) for possible action to be taken to safeguard the integrity of the riser.

1. A subsea riser integrity diagnosis system, comprising:
one or more optical fibres deployed along at least a portion of a riser;
a fibre optic sensor interrogation apparatus optically coupled to the one or more optical fibres and operable to detect at least one of temperature, vibration, and strain; and
a central processor means adapted to receive measurement data from the fibre optic sensor interrogation apparatus and operable to determine from the received data a status of at least one of temperature, vibration, and strain along at least a portion of the riser, and to determine if the status is within a predetermined safe limit or whether a potentially damaging event has occurred and to inform an operator of a possible action to be taken to safeguard riser integrity.

2. The subsea riser integrity diagnosis system as claimed in claim 1, where multiple optical fibres are employed to measure at least a portion of the riser at different radial and/or azimuthal positions.

3. The subsea riser integrity diagnosis system as claimed in claim 1, wherein the fibre optic sensor interrogation apparatus comprises a fibre optic strain sensor for determining strain along at least a portion of the riser, and wherein the fibre optic strain sensor comprises an optical fibre forming a distributed fibre optic strain sensor.

4. The subsea riser integrity diagnosis system as claimed in claim 2, wherein the multiple optical fibres are arranged within a sensor carrier such that in use the multiple optical fibres are provided in a wound configuration around the outside of a pipeline.

5. The subsea riser integrity diagnosis system as claimed in claim 1, wherein the fibre optic sensor interrogation apparatus comprises a Brillouin or Rayleigh scattering fibre optic strain sensor for determining vibration along at least a portion of the riser.

6. (canceled)

7. The subsea riser integrity diagnosis system as claimed in claim 1, wherein the fibre optic sensor interrogation apparatus optically coupled to the one or more optical fibres comprises a plurality of fibre Bragg grating sensors.

8. The subsea riser integrity diagnosis system as claimed in claim 7, wherein the plurality of fibre Bragg grating sensors are provided within one optical fibre.

9. The subsea riser integrity diagnosis system as claimed in claim 1, wherein the central processor means is further operable to determine and identify event types selected from the group consisting of: excessive strain and potential for fatigue damage, extreme sea state conditions, extreme temperature and temperature variation, extreme flow conditions, slugging, leaks of produced fluids out of the riser, or leaks of seawater into the riser, breakage of armour wires in flexible risers, collision with fishing equipment, interactions with support vessels, interactions with ROVs, and interactions with marine life.

10. The subsea riser integrity diagnosis system as claimed in claim 1, wherein the central processor means is further operable to generate an alarm signal.

11. The subsea riser integrity diagnosis system as claimed in claim 1, wherein the central processor means is further operable to generate a control signal for transmission to a production management system.

12. The subsea riser integrity diagnosis system as claimed in claim 1, wherein the central processor means is further operable to execute a possible action to be taken to safeguard riser integrity wherein the possible action is selected from the group consisting of: decrease or increase a total flow rate within a pipeline, inject gas into the pipeline, and divert gas within a multiphase flow.

13. (canceled)

14. The subsea riser integrity diagnosis system as claimed in claim 1, wherein the portion of the riser is defined as an interval most subject to failure.

15. The subsea riser integrity diagnosis system as claimed in claim 1, wherein the riser extends between a surface production facility floating on a sea surface and a subsea infrastructure located on a seabed.

16. The subsea riser integrity diagnosis system as claimed in claim 1, wherein the fibre optic sensor interrogation apparatus optically coupled to the one or more optical fibres comprises a fibre optic distributed temperature sensing system for measuring temperature along the one or more optical fibres deployed along at least a portion of a riser.

17. A method for informing an operator of a possible action to be taken to safeguard the integrity of a riser, the method comprising the steps of:
deploying one or more optical fibres along at least a portion of a riser;
positioning a fibre optic sensor interrogation apparatus optically coupled to the one or more optical fibres and operable to detect at least one of temperature, vibration, and strain; and
providing a central processor means adapted to receive measurement data from the fibre optic sensor interrogation apparatus and operable to determine from the received data a status of at least one of temperature, vibration, and strain alone at least a portion of the riser, and to determine if the status is within a predetermined safe limit or whether a potentially damaging event has occurred and to inform an operator of a possible action to be taken to safeguard riser integrity.
